(19) United States
(12) Patent Application Publication
(10) Pub. No.: US 2016/0350462 A1
(43) Pub. Date: Dec. 1, 2016

(54) METHOD OF PLANNING ASYMMETRIC VARIABLE ACCELERATION BASED ON NON-LINEAR FINITE ELEMENT DYNAMIC RESPONSE SIMULATION

(71) Applicant: GUANGDONG UNIVERSITY OF TECHNOLOGY, Guangzhou (CN)

(72) Inventors: Xin Chen, Guangzhou (CN); Youdun Bai, Guangzhou (CN); Zhijun Yang, Guangzhou (CN); Jian Gao, Guangzhou (CN); Haidong Yang, Guangzhou (CN); Meng Wang, Guangzhou (CN)

(73) Assignee: GUANGDONG UNIVERSITY OF TECHNOLOGY, Guangzhou (CN)

(21) Appl. No.: 15/113,844

(22) PCT Filed: Sep. 24, 2014
(86) PCT No.: PCT/CN2014/087283

§ 371 Date: Jul. 25, 2016

(30) Foreign Application Priority Data
Jun. 10, 2014 (CN) 201410255068.4

(51) Int. Cl. G06F 17/50; G06T 17/10

(52) U.S. Cl. CPC G06F 17/5018; G06T 17/10

(57) ABSTRACT

Various embodiments relate to a method of planning asymmetric variable acceleration based on non-linear finite element dynamic response simulation. The planning method involves obtaining solution of a non-linear finite element model positioning process that has kinematic freedom and adopts a parameterized motion function as its boundary condition; determining whether post-driving amplitude of an execution end satisfies positioning precision, and if it does not, continuing getting solution, and if it is, adjusting an energy decay time; determining whether a target response time is minimum, and if it is, verifying the set motion parameter as optimal, and if it is not, calculating a gradient and a step size of the motion parameter, and resetting the motion parameter for solution. The present disclosure utilizes this method to plan high-speed high-acceleration motion for mechanisms that are affected by non-linear factors such as large flexible deformation and require precise positioning.

### RELATED APPLICATIONS

The present application is a national stage entry according to 35 U.S.C. §371 of PCT application No.: PCT/CN2014/087283 filed on Sep. 24, 2014, which claims priority from China Patent application No.: 201410255068.4 filed on Jun. 10, 2014, and is incorporated herein by reference in its entirety.

### TECHNICAL FIELD

Various embodiments generally relate to the fields of mechanical engineering and mathematics, and more particularly to a method of planning asymmetric variable acceleration based on non-linear finite element dynamic response simulation.

### BACKGROUND

A mechanism with motion acceleration above 10 g is regarded as a “flexible body”, which has its dynamic properties significantly different from those of a rigid-body mechanism. Such a high-acceleration executing mechanism is highly affected by inertial energy, and thus suffers great residual vibration during high-acceleration motion such as high-speed start and stop. After residual vibration, the mechanism's flexible vibration energy will require long decay time before satisfying the requirements for precise positioning again. For ensuring that a high-speed high-acceleration executing mechanism achieves precise positioning, the most common approach is to plan smooth motion acceleration curves so as to minimize the impact caused by vibration generated acceleration during high-speed motion. One example is S-curve planning technology popular in the manufacturing industry.

The traditional approach is about planning motion so as to accomplish geometric smoothness of the motion acceleration curve. Since the known motion planning method provides no optimization in view of the mechanism's innate physical properties such as rigidity, inertia, and inherent frequency, the motion curve obtained thereby may generate harmonic waves. Therefore, some scholars have proposed eliminating harmonic components by means of wave filtering. However, the improved method nevertheless has two problems: 1) a mechanism's inherent frequency changes with its motion, and it is therefore needed an adjustable bandpass filter; and 2) after wave filtering, the motion may fail to reach the intended position and make additional motion compensation needed, thus degrading the efficiency.

For addressing the foregoing problems, China Patent No. 201310460878.9 provides a method for planning s-curve motion using flexible multibody dynamics simulation so as to reduce residual vibration. This method uses dynamic design instead of geometric design, thereby being highly applicable.

However, there are some high-speed devices that require the highest possible velocity, such as those for microelectronic packaging. In such a device, the whole motion includes only acceleration and deceleration, without ant uniform-velocity sections. The wideband vibration caused to mechanisms during full-speed start and stop poses limitation to application of flexible multibody dynamics based on the assumption of small deformation. Thus, it is necessary to introduce a new method to solve high-speed mechanisms' dynamic response.

China Patent No. 201310460878.9 provides a method for planning s-curve motion for a high-speed mechanism with the attempt to reduce residual vibration. The known method considers the impact of decay of flexible vibration of a mechanism on the mechanism's positioning time, and adds a decay-time section to the traditional s-motion planning method, thereby creating a s-curve planning model that achieves the shortest possible positioning time with consideration of the influence of residual vibration on a high-speed mechanism, thereby better ensuring the high-speed mechanism's smooth motion and short positioning time. China Patent No. 201310460878.9 provides a method using a high-precision truncated dynamic sub-structure approach to create a flexible multibody dynamics model for an executing mechanism. The flexible multibody dynamics model remains unchanged during the subsequent adjustment and optimization of motion parameters. When the executing mechanism further increases its motion acceleration, the executing mechanism's response will show a strong non-linear nature. Modification to the motion parameters will greatly affect the executing mechanism's response to flexible vibration. In other word the flexible multibody dynamics model will change significantly, and this limits the method of China Patent No. 201310460878.9 to occasions where a high-speed executing mechanism motion with less non-linear influence

### SUMMARY

The present disclosure utilizes this method to plan high-speed high-acceleration motion for mechanisms that are aff4ected by non-linear factors such as large flexible deformation and require precise positioning The method contributes to precise positioning and smooth position-force transition under high acceleration, and is also applicable to motion planning for mechanisms using traditional resolution.

For achieving the foregoing objective, the present disclosure adopts the following technical scheme:

a method of planning asymmetric variable acceleration based on non-linear finite element dynamic response simulation includes the following steps:

Step I. according to a geometric model of a mechanism, establishing a finite element assembly model that has kinematic freedom, and creating a plan for non-linear finite element analysis and solution;

Step II. Setting a motion parameter so as to obtain a parameterized function for asymmetric motion and applying the function as a boundary condition to the non-linear finite element model;

Step III. Performing positioning process simulation on the parameterized function, and getting a real-time dynamic process response curve through non-linear finite element solution;

Step IV. determining whether post-driving amplitude of the real-time vibration response curve satisfies a positioning precision, and where it does not, calculating a gradient and a step size, modifying the motion function parameter, and proceeding with Step III; and where it does, making termination on the non-linear finite element solution process of Step III, obtaining a time T to said termination, and entering Step V; and

Step V. by measuring a driving time and an inertial energy decay time, determining whether the target response time T is minimum, and where it is, verifying that the set motion parameter is optimal; and where it is not, calculating the gradient and the step size of the motion parameter, resetting the motion parameter, and entering Step III for solution.

Step I includes the following steps:

a. establishing the three-dimensional geometric model of the mechanism;

b. defining material properties of the three-dimensional model using finite element software and performing network partition, so as to convert the three-dimensional geometric model into the finite element model;

c. creating motion constraints at motion joints of the mechanism, so as to establish the finite element assembly model that has kinematic freedom for the mechanism in a finite element analysis environment;

d. driving the joints, and applying the parameterized function as the boundary condition; and

e. creating the plan for non-linear finite element analysis and solution.

According to definition of the asymmetric motion, the motion is divided into: an acceleration-acceleration section (T₁) with jerk G₁; a deceleration-acceleration section (T₂) with jerk G₂; a deceleration-acceleration section (T₃) with jerk G₃; and a deceleration-deceleration section (T₄) with jerk G₄; and a decay time T₅ is added in consideration of inertial energy.

During the s-shaped asymmetric motion, the jerk of each said section is a constant, and when each said section ends, velocity and acceleration are both zero, so constraint of the following equation applies:

T₁G₁=T₂G₂

T₃G₃=T₄G₄

T₁G₁(T₁+T₂)=T₃G₃(T₃+T₄)

wherein it is possible to express each of T₂, T₃ and T₄ with T₁.

The decay time T₅ is determined using the following equation:

abs(s−s*)+abs(v)<ε

where during residual vibration, velocity v is greater than displacement s, and the equation is only true when velocity v is almost 0, namely that mechanism position s is within a range defined by positioning precision ε.

In Step V the optimized model is:

T=T₁30 T₂+T₃+T₄+T₅

Find(G₁,G₂,G₃,G₄)

Objective:Min(T)

Subject to: abs(s−s*)+abs(v)<ε

T₁G₁=T₂G₂

T₃G₃=T₄G₄

T₁G₁(T₁+T₂)=T₃G₃(T₃+T₄)

With the principle described above, the present disclosure aimed at the objective of achieving the shortest possible positioning time while satisfying the desired positioning precision provides a planning method for asymmetric variable acceleration with the optimal distribution of inertial energy time. The method involves solving the non-linear finite element model positioning process that has kinematic freedom and takes a parameterized motion function as its boundary condition; determining whether the post-driving amplitude of the execution end satisfies the positioning precision, and if not, keeping solving, and if yes, vibrating the energy decay time; determining whether the target response time (the sum of the driving time and the vibration energy decay time) is minimum, and if yes, setting the set motion parameter as the optimal parameter, and if not, calculating the motion parameter's gradient and step size, and resetting the motion parameter for solution. The disclosed method particularly features that it employs a non-linear finite element solving module to analyze a mechanism's inertial energy properties throughout the time history with full consideration of the influence brought by wideband vibration during high-speed start and stop. This feature ensures that the disclosed method is applicable to optimization of motion planning for non-linear high-speed high-acceleration mechanisms. The disclosed method is also applicable to optimization of motion planning for traditional executing mechanisms. In addition, the disclosed method is helpful to prevent mechanism's motion from generating harmonic components, and favorable to ensure precise positioning and smooth position-force transition in high-speed conditions.

### BRIEF DESCRIPTION OF THE DRAWINGS

FIG. 1 is a flow chart of one embodiment of the present disclosure.

FIG. 2 is a curve diagram of asymmetric motion according to one embodiment of the present disclosure.

FIG. 3 is a diagram showing displacement curves of different velocity planning schemes according to one embodiment of the present disclosure.

FIG. 4 is a diagram showing inertial energy decay curves of the velocity planning schemes of FIG. 3.

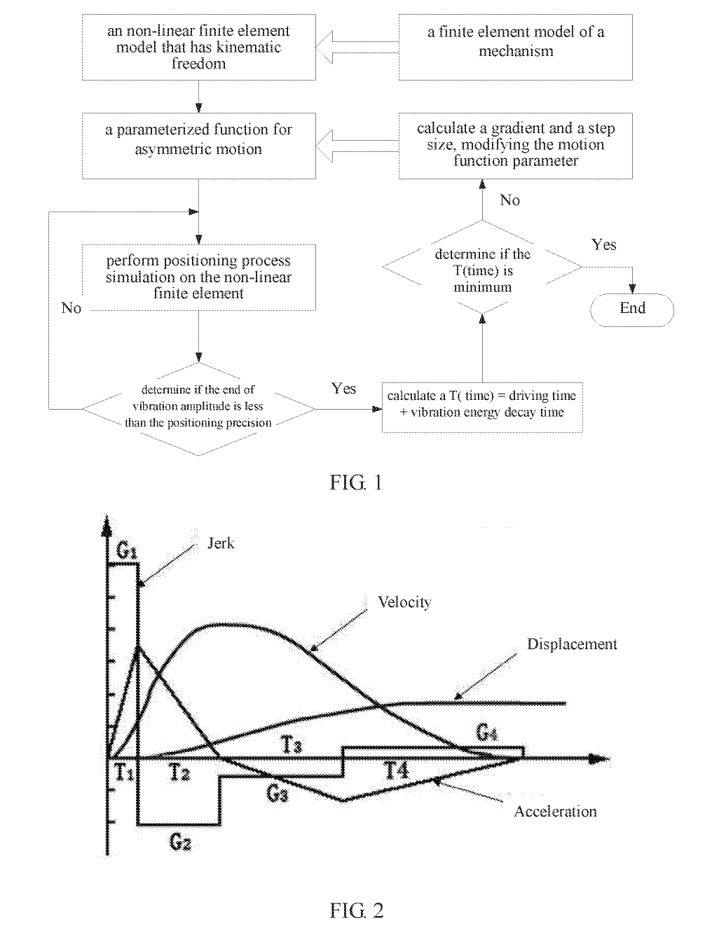

### DETAILED DESCRIPTION

The technical scheme of the disclosure will be best understood by reference to the following detailed description of illustrative embodiments when read in conjunction with the accompanying drawings.

The disclosed method of planning asymmetric variable acceleration based on non-linear finite element dynamic response simulation includes the following steps:

Step I. according to a geometric model of a mechanism, establishing a finite element assembly model that has kinematic freedom, and creating a plan for non-linear finite element analysis and solution;

Step II. Setting a motion parameter so as to obtain a parameterized function for asymmetric motion and applying the function as a boundary condition to the non-linear finite element model;

Step III. Performing positioning process simulation on the parameterized function, and getting a real-time dynamic process response curve through non-linear finite element solution;

Step IV. determining whether post-driving amplitude of the real-time vibration response curve satisfies a positioning precision, and where it does not, calculating a gradient and a step size, modifying the motion function parameter, and proceeding with Step III; and where it does, making termination on the non-linear finite element solution process of Step III, obtaining a time T to said termination, and entering Step V; and

Step V. by measuring a driving time and an inertial energy decay time, determining whether the target response time T is minimum, and where it is, verifying that the set motion parameter is optimal; and where it is not, calculating the gradient and the step size of the motion parameter, resetting the motion parameter, and entering Step III for solution.

Step I includes the following steps:

a. establishing the three-dimensional geometric model of the mechanism;

b. defining material properties of the three-dimensional model using finite element software and performing network partition, so as to convert the three-dimensional geometric model into the finite element model;

c. creating motion constraints at motion joints of the mechanism, so as to establish the finite element assembly model that has kinematic freedom for the mechanism in a finite element analysis environment;

d. driving the joints, and applying the parameterized function as the boundary condition; and

e. creating the plan for non-linear finite element analysis and solution.

According to definition of the asymmetric motion, the motion is divided into: an acceleration-acceleration section (T₁) with jerk G₁; a deceleration-acceleration section (T₂) with jerk G₂; a deceleration-acceleration section (T₃) with jerk G₃; and a deceleration-deceleration section (T₄) with jerk G₄; and a decay time T₅ is added in consideration of inertial energy.

During the s-shaped asymmetric motion, the jerk of each said section is a constant, and when each said section ends, velocity and acceleration are both zero, so constraint of the following equation applies:

T₁G₁=T₂G₂

T₃G₃=T₄G₄

T₁G₁(T₁+T₂)=T₃G₃(T₃+T₄)

wherein it is possible to express each of T₂, T₃ and T₄ with T₁.

The decay time T₅ is determined using the following equation:

abs(s−s*)+abs(v)<ε

where during residual vibration, velocity v is greater than displacement s, and the equation is only true when velocity v is almost 0, namely that mechanism position s is within a range defined by positioning precision ε.

In Step V the optimized model is:

T=T₁30 T₂+T₃+T₄+T₅

Find(G₁,G₂,G₃,G₄)

Objective:Min(T)

Subject to: abs(s−s*)+abs(v)<ε

T₁G₁=T₂G₂

T₃G₃=T₄G₄

T₁G₁(T₁+T₂)=T₃G₃(T₃+T₄)

Assuming that Q=s* is the target displacement, the time for each of the motion curves can be obtained by solving the equation with the constraint:

Wherein:

A=2G₁²G₃²G₄+2G₁²G₃G₄²+3G₁G₂G₃²G₄+3G₁G₂G₃G₄²+G₂²G₃²G₄+G₂²G₃G₄²

B=G₁G₃{square root over (G₂G₃(G₃+G₄)G₁G₄(G₁G₄(G1+G2))}+2G₁G₄{square root over (G₂G₃(G₂G₃(G₃+G₄)G₁G₄(G₁+G₂))}

C=G₂G₃\sqrt{G₂G₃(G₃+G₄)G₁G₄(G₁+G₂)}

D=2G₂G₄{square root over (G₂G₃(G₃+G₄)G₁G₄(G₁+G₂)))}

E=QG₂²G₃G₄(G₃+G₄)G₁²

F=2G₁²G₃²G₄+2G₁²G₃G₄²+3G₁G₂G₃²G₄+3G₁G₂G₃G₄²+G₂²G₃²G₄+G₂²G₃G₄²

G=G₁G₃\sqrt{G₂G₃(G₃+G₄)G₁G₄(G₁+G₂)}

H=2G₂G₄{square root over (G₂G₃(G₃+G₄)G₁G₄(G₁+G₂)))}

I=G₂G₃\sqrt{G₂G₃(G₃+G₄)G₁G₄(G₁+G₂)}

J=2G₂G₄{square root over (G₂G₃(G₃+G₄)G₁G₄(G₁+G₂)))}

the time for each of the motion curves is:

$$T 1 = \sqrt[3]{\frac{\sqrt[3]{6} {E ( F + G + H + I + J )}^{2}}{{G}_{1} ( A + B + C + D )}}$$

$${T}_{2} = \frac{{G}_{1} {T}_{1}}{{G}_{2}}$$

$${T}_{3} = {T}_{1} \sqrt{\frac{{G}_{1} ( 1 + \frac{{G}_{1}}{{G}_{2}} )}{{G}_{3} ( 1 + \frac{{G}_{3}}{{G}_{4}} )}}$$

$${T}_{4} = \frac{{T}_{3} {G}_{3}}{{G}_{4}}$$

$$T 4 = ( T 3 * G 3 \text{/} G 4 )$$

### EXAMPLE

A swing-type welding head mechanism of a high-speed die bonder is required to move from a die-taking site in high speed to a die-bonding site with positioning precision of at least ±1 μm and get positioned in the minimum positioning time. According to optimization of the symmetric s-shaped acceleration curve, it was obtained that the shortest positioning time is 23.33 ms (the driving time of 17.90 ms, the maximum residual amplitude of 2.14 μm, and the inertial energy decay time of 5.43 ms). Then the disclosed asymmetric variable acceleration planning was used for further optimization, and the process is as shown in Table 1 below. With the same positioning precision of ±1 μm, the positioning time became 16.36 ms (the driving time of 12.90 ms, the maximum residual amplitude of 1.03 μm, and the inertial energy decay time of 3.46 ms), meaning 30% shorter (with the inertial energy decay time reduced by 36%).

TABLE 1
Optimization Process

| | | | | | | Driving | Max | |
|---|---|---|---|---|---|---|---|---|
| | Positioning | Jerk | Jerk | Jerk | Jerk | Time | Amplitude | Decay Time |
| Repetition | Time (ms) | G1 (°/s3) | G2 (°/s3) | G3 (°/s3) | G4 (°/s3) | (ms) | (μm) | (ms) |
| 0 (Initial) | 23.33 | 1.00E+09 | 1.00E+09 | 1.00E+09 | 1.00E+09 | 17.90 | 2.14 | 5.43 |
| 1 | 14.80 | 2.56E+11 | 1.28E+11 | 4.12E+11 | 5.08E+08 | 13.30 | 1.19 | 1.50 |
| 2 | 14.80 | 2.56E+11 | 1.28E+11 | 4.12E+11 | 5.08E+08 | 13.30 | 1.19 | 1.50 |
| 3 | 14.80 | 2.56E+11 | 1.28E+11 | 4.12E+11 | 5.08E+08 | 13.30 | 1.19 | 1.50 |
| 4 (Optimized) | 16.36 | 2.56E+11 | 1.28E+11 | 4.12E+11 | 5.58E+08 | 12.90 | 1.03 | 3.46 |
| Equivlant | 21.94 | 2.67E+09 | 2.67E+09 | 2.67E+09 | 2.67E+09 | 12.90 | 4.65 | 9.04 |
| Symmetric | | | | | | | | |

For better comparison with symmetric acceleration, the driving time of 12.90 ms was used to calculate the symmetric s-curve motion parameter and got the jerk of 2.67E+09(°/s³). With the same positioning precision, the maximum residual vibration amplitude was 4.65 μm, and the inertial energy decay time was 9.04 ms. As compared to symmetric s-shaped variable acceleration planning, the asymmetric s-shaped variable acceleration motion planning had 62%-shorter inertial energy decay time and 25%-shorter total positioning time.

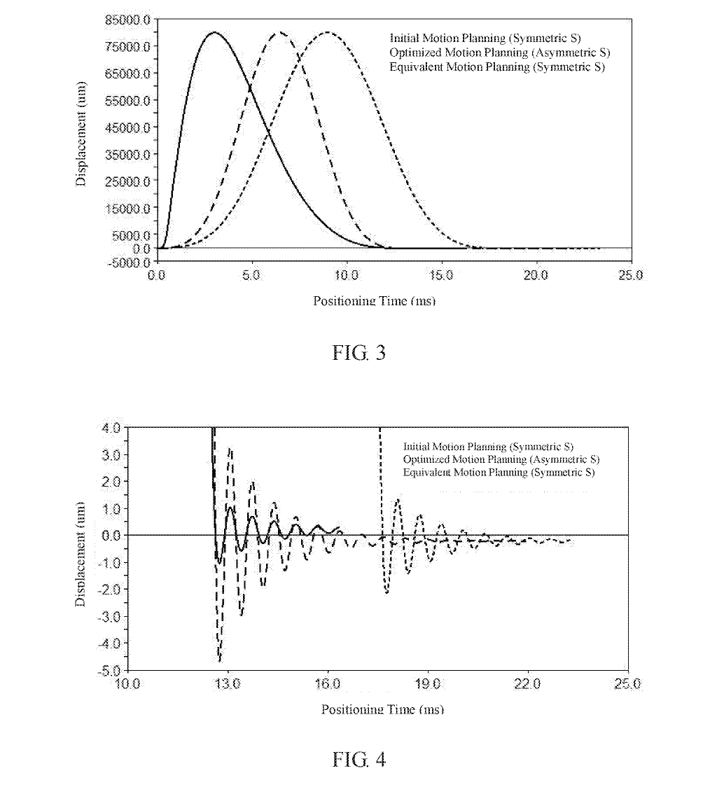

As shown in FIG. 3 an FIG. 4, during the asymmetric variable acceleration curve motion, the basic frequency appeared earlier, so as to provide more decay time to the generated vibration, thereby making the distribution of the inertial energy more reasonable. This effectively improves the mechanism in terms of dynamic performance during high-speed, high-acceleration motion. In this way, the executing mechanisms highly demanding in precision such as microelectronic packaging devices can be provided with better execution efficiency.

With the principle described above, the present disclosure aimed at the objective of achieving the shortest possible positioning time while satisfying the desired positioning precision provides a planning method for asymmetric variable acceleration with the optimal distribution of inertial energy time. The method involves performing discretization of non-linear finite element dynamic response equation in terms of time history for a high-speed high-acceleration mechanism having kinematic freedom, inversely reducing the kinematic freedom equation into flexible freedom in a border sense, and then using immediate integration to get impact responses during high-acceleration start and stop processes. The disclosed method particularly features that it employs a non-linear finite element solving module to analyze a mechanism's inertial energy properties throughout the time history with full consideration of the influence brought by wideband vibration during high-speed start and stop. This feature ensures that the disclosed method is applicable to optimization of motion planning for non-linear high-speed high-acceleration mechanisms. The disclosed method is also applicable to optimization of motion planning for traditional executing mechanisms. In addition, the disclosed method is helpful to prevent mechanism's motion from generating harmonic components, and favorable to ensure precise positioning and smooth position-force transition in high-speed conditions.

While the disclosed embodiments have been particularly shown and described with reference to specific embodiments, it should be understood by those skilled in the art that various changes in form and detail may be made therein without departing from the spirit and scope of the disclosed embodiments as defined by the appended claims The scope of the disclosed embodiments is thus indicated by the appended claims and all changes which come within the meaning and range of equivalency of the claims are therefore intended to be embraced.

1. A method of planning asymmetric variable acceleration based on non-linear finite element dynamic response simulation, wherein the planning method comprises:
Step I. according to a geometric model of a mechanism, establishing a finite element assembly model that has kinematic freedom, and creating a plan for non-linear finite element analysis and solution;
Step II. Setting a motion parameter so as to obtain a parameterized function for asymmetric motion and applying the function as a boundary condition to the non-linear finite element model;
Step III. Performing positioning process simulation on the parameterized function, and getting a real-time dynamic process response curve through non-linear finite element solution;
Step IV. determining whether post-driving amplitude of the real-time vibration response curve satisfies a positioning precision, and where it does not, calculating a gradient and a step size, modifying the motion function parameter, and proceeding with Step III; and where it does, making termination on the non-linear finite element solution process of Step III, obtaining a time T to said termination, and entering Step V; and
Step V. by measuring a driving time and an inertial energy decay time, determining whether the target response time T is minimum, and where it is, verifying that the set motion parameter is optimal; and where it is not, calculating the gradient and the step size of the motion parameter, resetting the motion parameter, and entering Step III for solution.

2. The method of claim 1, wherein Step I comprises the following:
a. establishing the three-dimensional geometric model of the mechanism;
b. defining material properties of the three-dimensional model using finite element software and performing network partition, so as to convert the three-dimensional geometric model into the finite element model;
c. creating motion constraints at motion joints of the mechanism, so as to establish the finite element assembly model that has kinematic freedom for the mechanism in a finite element analysis environment;
d. driving the joints, and applying the parameterized function as the boundary condition; and
e. creating the plan for non-linear finite element analysis and solution.

3. The method of claim 1, wherein according to definition of the asymmetric motion, the motion is divided into: an acceleration-acceleration section (T₁) with jerk G₁; a deceleration-acceleration section (T₂) with jerk G₂; a deceleration-acceleration section (T₃) with jerk G₃; and a deceleration-deceleration section (T₄) with jerk G₄; and a decay time T₅ is added in consideration of inertial energy.

4. The method of claim 3, wherein during the s-shaped asymmetric motion, the jerk of each said section is a constant, and when each said section ends, velocity and acceleration are both zero, so constraint of the following equation applies:
T₁G₁=T₂G₂
T₃G₃=T₄G₄
T₁G₁(T₁+T₂)=T₃G₃(T₃+T₄)
wherein it is possible to express each of T₂, T₃ and T₄ with T₁.

5. The method of claim 3, being characterized in that wherein the decay time T₅ is determined using the following equation:
abs(s−s*)+abs(v)<ε
where during residual vibration, velocity v is greater than displacement s, and the equation is only true when velocity v is almost 0, namely that mechanism position s is within a range defined by positioning precision ε.

6. The method of claim 1, wherein in Step V the optimized model is:
T=T₁30 T₂+T₃+T₄+T₅
Find(G₁,G₂,G₃,G₄)
Objective:Min(T)
Subject to: abs(s−s*)+abs(v)<ε
T₁G₁=T₂G₂
T₃G₃=T₄G₄
T₁G₁(T₁+T₂)=T₃G₃(T₃+T₄)
